(19) United States
(12) Patent Application Publication
(10) Pub. No.: US 2021/0301412 A1
(43) Pub. Date: Sep. 30, 2021

(54) Cu1 81S CATALYST FOR SYNTHESIZING NH3 AND METHOD FOR SYNTHESIZING NH3 USING THE SAME

(71) Applicant: Korea Institute of Science and Technology, Seoul (KR)

(72) Inventors: Sang Soo Han, Seoul (KR); Seung Yong Lee, Seoul (KR); Hyun S. Park, Seoul (KR); Min Cheol Kim, Seoul (KR); Hyun Ji Nam, Seoul (KR); Ji Hyun Choi, Seoul (KR)

(73) Assignee: Korea Institute of Science and Technology, Seoul (KR)

(21) Appl. No.: 17/104,427

(22) Filed: Nov. 25, 2020

(30) Foreign Application Priority Data
Mar. 25, 2020 (KR) 10-2020-0036470

(51) Int. Cl. C25B 11/075; C01G 3/12; C01C 1/04; C25B 1/50; C25B 1/27

(52) U.S. Cl. CPC C25B 11/075; C01G 3/12; C01C 1/0494; C25B 1/50; C25B 1/27; C01P 2004/03; C01P 2002/72; C01P 2002/77; C01P 2002/84; C01P 2004/04; C01P 2002/76

(57) ABSTRACT

The present disclosure provides a Cu_{1.81}S catalyst for synthesizing NH₃ and a method for synthesizing NH₃ using the same. According to the present disclosure, the Cu_{1.81}S catalyst is provided in order to increase an efficiency of NH₃ synthesis. A copper sulfide catalyst and the method for synthesizing NH₃ via an electrochemical nitrogen reduction reaction (NRR) using the Cu_{1.81}S catalyst are provided in order to reduce a limiting potential (UL) required for the NRR. In the NRR for the NH₃ synthesis, it is provided the copper sulfide catalyst that can be used in any one of two different pathways for the NRR, and the method for synthesizing NH₃ with higher activity of the NRR based thereon.

### FIELD OF THE DISCLOSURE

The present disclosure relates to a Cu_{1.81}S catalyst for synthesizing NH₃ and a method for synthesizing NH₃ using the same.

### BACKGROUND OF THE DISCLOSURE

There have been many studies on a method for producing ammonia (NH₃) since ammonia is used as a material for fertilizer and thus takes a big role in increasing food production. Mass production of ammonia was achieved due to the Haber-Bosch process, which is the most representative method for synthesizing ammonia.

However, in the Haber-Bosch process, high temperature and pressures are required in order to break the triple bond of a nitrogen molecule (N₂). Therefore, the Harber-Bosch process requires its facility in a large scale and a high cost for production. In addition, it has a disadvantage of a generation of carbon dioxide, i.e., a greenhouse gas, during the process of synthesizing ammonia.

Accordingly, many studies have recently been conducted with the electrochemical nitrogen reduction reactions (NRR) for synthesizing ammonia. One of them is a study for bioinspired catalysts inspired by the Fe—Mo—S cofactor mechanism in the nitrogenase enzyme by which ammonia is synthesized through nitrogen adsorption.

However, as the metal atom Fe or Mo tends to have an oxidation number of 2 or higher, it is difficult to design sulfide catalysts with ratios of metal/sulfur higher than 1.

Therefore, there is still a need for a new metal sulfide catalyst that can be designed to have a higher ratio of the number of metal atoms to that of S atoms in order to increase the efficiency of NH₃ synthesis.

### SUMMARY OF THE INVENTION

It is an object of the present disclosure to solve all the aforementioned problems.

It is another object of the present disclosure to provide a copper sulfide catalyst to be used for increasing the efficiency of NH₃ synthesis.

It is still another object of the present disclosure to provide the copper sulfide catalyst that can be designed to have a ratio of the number of Cu atoms to that of S atoms to be higher than 1.

It is still yet another object of the present disclosure to provide the copper sulfide catalyst which can reduce limiting potential (UL) required for a nitrogen reduction reaction (NRR), and a method for synthesizing NH₃ using the copper sulfide catalyst.

It is still yet another object of the present disclosure to provide the copper sulfide catalyst to proceed one of two different pathways of the NRR for the NH₃ synthesis, and the method for synthesizing NH₃ with a higher activity of the NRR by using the copper sulfide catalyst.

In order to accomplish objects above, representative structures of the present disclosure are described as follows.

In accordance with one aspect of the present invention, there is provided a copper sulfide catalyst having a chemical formula of Cu_{1.81}S.

As one example, the copper sulfide catalyst is used for synthesizing NH₃ molecules via an electrochemical nitrogen reduction reaction (NRR).

As one example, a plurality of 3-fold coordination sites, each of which is comprised of each group of three Cu atoms, are formed on a surface of the copper sulfide catalyst.

As one example, a structure of the copper sulfide catalyst is tetragonal.

In accordance with another aspect of the present invention, there is provided a method for synthesizing NH₃ by using the copper sulfide catalyst according to any one of claims 1 to 4, including steps of: (a) adsorbing an N₂ molecule to at least one specific Cu atom of the three Cu atoms in a specific group within a specific 3-fold coordination site among the 3-fold coordination sites formed on the surface of the copper sulfide catalyst; (b) bonding an H⁺ ion to a specific S(sulfur) atom adjacent to the specific 3-fold coordination site; and (c) (i) bonding one of two N atoms of the adsorbed N₂ molecule to one of the three Cu atoms in the specific group within the specific 3-fold coordination site, and the other one of the two N atoms to the other ones of the three Cu atoms in the specific group, and (ii) providing the H⁺ ion to a first N atom of the two N atoms from the specific S atom as a proton donor, to thereby produce an N₂H molecule as a first intermediate, and form a hydrogen bond between the specific S atom and the H⁺ ion provided to the first N atom.

As one example, after the step of (c), the NH₃ is synthesized by one of (i) a first reaction pathway which is initiated when a first additional H⁺ ion is bonded to the first N atom included in the first intermediate, and (ii) a second reaction pathway which is initiated when the first additional H⁺ ion is bonded to a second N atom of the two N atoms included in the first intermediate.

As one example, the method further includes steps of: (d1) producing an N₂H₂ molecule as a (2_1)-st intermediate by bonding the first additional H⁺ ion to the first N atom included in the first intermediate; and (d2) bonding a second additional H⁺ ion to the first N atom included in the (2_1)-st intermediate so that the first N atom is separated from the (2_1)-st intermediate in a form of a (1_1)-st NH₃ and the second N atom remains as a third intermediate on the surface of the copper sulfide catalyst, wherein the steps of (d1) and (d2) are performed in the first reaction pathway.

As one example, the method further includes steps of: (e1) producing an NH molecule as a fourth intermediate by bonding a third additional H⁺ ion to the third intermediate; (e2) producing an NH₂ molecule as a fifth intermediate by bonding a fourth additional H⁺ ion to the second N atom included in the fourth intermediate; and (e3) producing a (2_1)-st NH₃ molecule by bonding a fifth additional H⁺ ion to the second N atom included in the fifth intermediate, wherein the steps of (e1) to (e3) are performed in the first reaction pathway.

As one example, the method further includes steps of: (f1) producing an N₂H₂ molecule, which has a condensed structural formula of NHNH, as a (2_2)-nd intermediate by bonding the first additional H⁺ ion to the second N atom included in the first intermediate; (f2) producing an N₂H3 molecule as a sixth intermediate by bonding a sixth additional H⁺ ion to one N atom among the first and the second N atoms included the (2_2)-nd intermediate; and (f3) bonding a seventh additional H⁺ ion to said one N atom, to which the first and the sixth additional ions have already been bonded, included in the sixth intermediate so that said one N atom is separated from the sixth intermediate in a form of a (1_2)-nd NH₃ molecule and an NH molecule remains as a seventh intermediate on the surface of the copper sulfide catalyst, wherein the steps of (f1) to (f3) are performed in the second reaction pathway.

As one example, the method further includes steps of: (g1) producing an NH₂ molecule as an eighth intermediate by bonding an eighth additional H⁺ ion to the other N atom among the first and the second N atoms which is included in the seventh intermediate; and (g2) producing a (2_2)-nd NH₃ molecule by bonding a ninth additional H⁺ ion to said other N atom included in the eighth intermediate, wherein the steps of (g1) and (g2) are performed in the second reaction pathway.

As one example, the nitrogen reduction reaction (NRR) is performed under conditions of a 0.1M KOH electrolyte solution, and room temperature and pressure.

### BRIEF DESCRIPTION OF THE DRAWINGS

FIG. 1 is a drawing illustrating TEM-EDS images and XRD graph, atomic arrangements, and RDF graphs of copper sulfide catalysts CuS, Cu_{1.81}S, and Cu₂S, in accordance with one example embodiment of the present disclosure.

FIG. 2A is a drawing illustrating NH₃ production rates and Faradaic Efficiencies (F.E.) to potentials (V versus reversible hydrogen electrode) of the CuS, Cu_{1.81}S, and Cu₂S composites, and monometallic Fe and Cu, in accordance with one example embodiment of the present disclosure.

FIG. 2B is a drawing illustrating experimental data of highest actives of the copper sulfide catalysts CuS, Cu_{1.81}S, and Cu₂S, and conventional bioinspired catalysts FeS₂ and MoS₂ in nitrogen reduction reactions(NRR) for the NH₃ synthesis, in accordance with one example embodiment of the present disclosure.

FIG. 3A is a drawing schematically illustrating pathways of a nitrogen reduction reaction for the NH₃ synthesis which are initiated by adsorption of N₂ molecules on a surface of Cu_{1.81}S, in accordance with one example embodiment of the present disclosure.

FIG. 3B is a drawing illustrating free-energy diagrams of the NRRs on the Cu_{1.81}S composite, the monometallic Cu, and the monometallic Fe as catalysts for the NH₃ synthesis, in accordance with one example embodiment of the present disclosure.

FIG. 3C is a drawing schematically illustrating a state that a hydrogen bond is formed between an S atom and an H⁺ ion of an N₂H molecule, which is generated as a first intermediate at a specific 3-fold coordination site formed on the Cu_{1.81}S, in accordance with one example embodiment of the present disclosure.

FIG. 4 is a drawing schematically illustrating methods of synthesizing the Cu_{1.81}S composite from a Cu—S mixture, in accordance with one example embodiment of the present disclosure.

FIG. 5 is a drawing illustrating XRD graphs of results over time of a ball-milling process of the Cu—S mixture, and SEM images of the Cu_{1.96} composite and the Cu_{1.81}S composite, each of which is produced by the ball-milling process for each certain period of the execution time, in accordance with one example embodiment of the present disclosure.

FIG. 6A is a drawing illustrating XRD graphs of the Cu_{1.96}S composite, which is produced by the ball-milling process of the Cu—S mixture, the Cu₂S composite, which is produced by annealing the Cu_{1.96}S composite, and the Cu_{1.81}S composite, which is produced by a wet-milling process of the Cu₂S composite, in accordance with one example embodiment of the present disclosure.

FIG. 6B is a drawing illustrating XRD graphs of the Cu_{1.81}S composites produced by the wet-milling process of the annealed Cu₂S composite for 24 hours and 72 hours respectively, in accordance with one example embodiment of the present disclosure.

FIG. 6C is a drawing illustrating XRD graphs and SEM images of the Cu_{1.81}S composite produced by the wet-milling process of the annealed Cu₂S composite for 72 hours, in accordance with one example embodiment of the present disclosure.

FIG. 6D is a drawing illustrating XRD graphs and SEM images showing that a result of the wet-milling process of the annealed Cu₂S composite for 12 hours is the Cu₂S composite, not the Cu_{1.81} composite, as an example for comparison with the present disclosure.

FIG. 7 is a drawing illustrating XRD graphs of products of the wet-milling process of the annealed Cu₂S composite using the different solvents, wherein the annealed Cu₂S composite is produced by annealing the Cu_{1.96}S composite produced by the ball-milling process of the Cu—S mixture, as examples for comparison with the present invention.

FIG. 8A is a drawing illustrating XRD graphs of a Cu_{1.96}S composite produced by the ball-milling process of the Cu—S mixture, and a Cu_{1.81}S composite produced by the wet-milling process of the Cu_{1.96}S composite, in accordance with one example embodiment of the present disclosure.

FIG. 8B is a drawing illustrating XRD graphs of Cu_{1.81}S composites produced by the wet-milling process of a Cu_{1.96}S composite for 12 hours and 24 hours respectively, wherein the Cu_{1.96}S composite is produced by the ball-milling process of the Cu—S mixture, in accordance with one example embodiment of the present disclosure.

FIG. 8C is a drawing illustrating XRD graphs and SEM images of the Cu_{1.81}S composite produced by the wet-milling process of the Cu_{1.96}S composite for 24 hours, wherein the Cu_{1.96}S composite is produced by the ball-milling process of the Cu—S mixture, in accordance with one example embodiment of the present disclosure.

FIG. 8D is a drawing illustrating XRD graphs and SEM images showing that a product of the wet-milling process of the Cu_{1.96}S composite for 72 hours is a Cu_{1.75}S composite, not the Cu_{1.81} composite, wherein the Cu_{1.96}S composite is produced by the ball-milling process of the Cu—S mixture, in accordance with one example embodiment of the present disclosure.

FIG. 9 is a drawing illustrating an XRD graph of a Cu_{1.81}S composite produced by the ball-milling process of the Cu—S mixture, in accordance with one example embodiment of the present disclosure.

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the disclosure.

Besides, in the detailed description and claims of the present disclosure, a term “include” and its variations are not intended to exclude other technical features, additions, components or steps. Other objects, benefits and features of the present disclosure will be revealed to those skilled in the art, partially from the specification and partially from the implementation of the present disclosure. The following examples and drawings will be provided as examples but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained in detail by referring to attached diagrams as shown below.

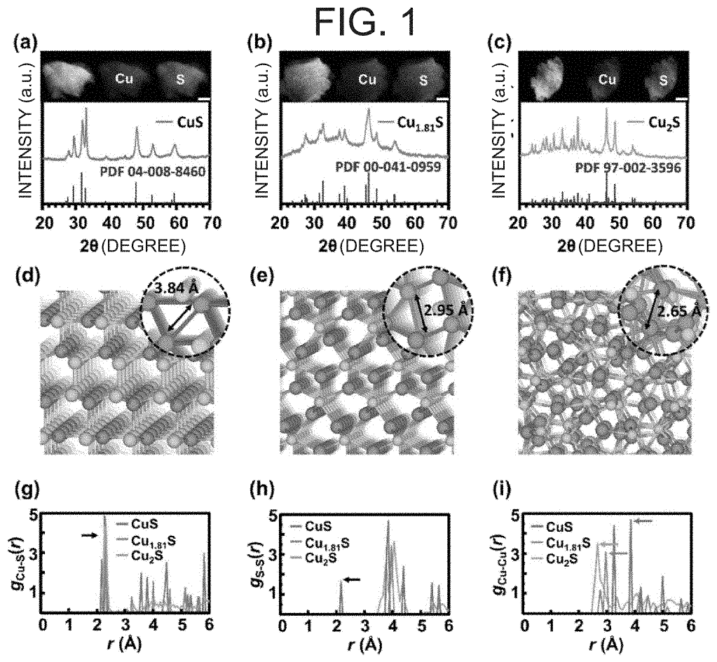

FIG. 1 is a drawing illustrating TEM-EDS images and XRD graphs, atomic arrangements, and RDF graphs of CuS, Cu_{1.81}S, and Cu₂S composites as catalysts, in accordance with one example embodiment of the present disclosure.

By referring to FIG. 1, the catalyst in the present disclosure may be a copper sulfide composite. Herein, the copper sulfide composite may have various chemical formulas depending on ratios of the number of Cu atoms to that of S atoms included therein. The ratio of the number of Cu atoms to that of S atoms may be 1 or higher since a Cu atom has an oxidation number as low as 1. Specifically, the catalyst in accordance with the present disclosure may be a copper sulfide catalyst having a chemical formula of Cu_{1.81}S. Further, the copper sulfide catalyst of the chemical formula of Cu_{1.81}S will be compared with other catalysts below.

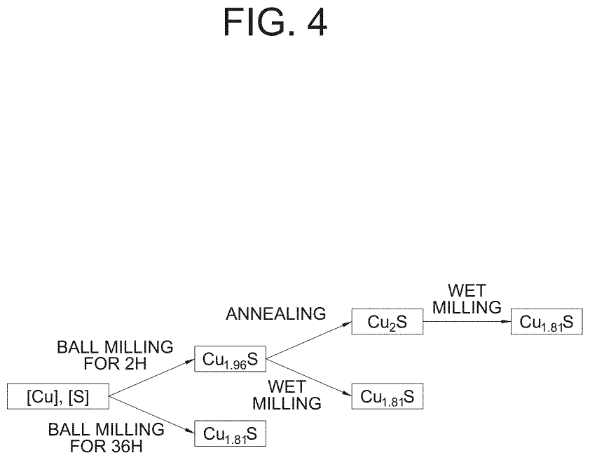

The copper sulfide catalyst Cu_{1.81}S in accordance with the present disclosure may be synthesized by a ball-milling process and a wet-milling process, and detailed descriptions thereof will be disclosed below in the part of [method of Cu_{1.81}S synthesis] by refereeing to FIGS. 4 to 9.

Also, the catalyst in accordance with the present disclosure may be used for synthesizing NH₃ molecules via an electrochemical nitrogen reduction reaction (NRR).

Hereinafter, example embodiments will be described on the premise that a process of NH₃ synthesis is performed by such an electrochemical nitrogen reduction reaction, but it is not excluded that the catalyst in accordance with the present disclosure may be used in NH₃ synthesis methods modified according to the implementation conditions of the present disclosure.

Referring to FIG. 1, structural characteristics of copper sulfide composites as catalysts in accordance with one embodiment of the present disclosure will be described in detail as follows.

A TEM-EDS image and an XRD graph of a CuS composite are shown in (a) of FIG. 1, those of a Cu_{1.81}S composite are shown in (b) of FIG. 1, and those of a Cu₂S composite are shown in (c) of FIG. 1. By referring to (a) to (c), it can be seen that the copper sulfide composites, i.e., CuS, Cu_{1.81}S, and Cu₂S, have Cu atoms and S atoms evenly dispersed in their particles and that they have different structures.

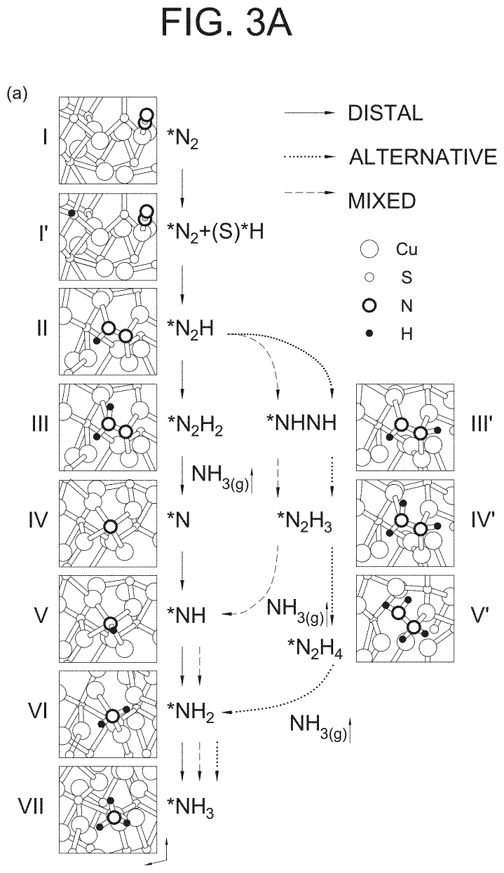

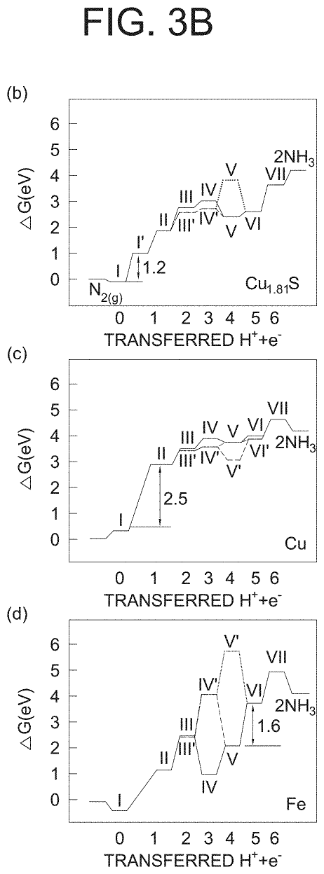

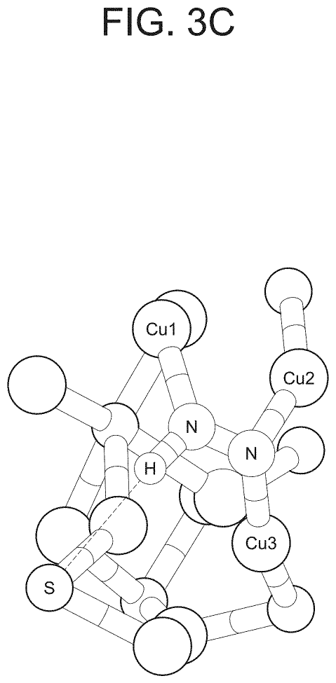

In (e) of FIG. 1, it is shown an atomic arrangement of the Cu_{1.81}S composite, wherein a bigger circle represents a Cu atom and a smaller circle represents an S atom. Referring to this, a structure of the Cu_{1.81}S composite may be tetragonal, and a plurality of 3-fold coordination sites, each of which is comprised of each group of three Cu atoms, may be formed on a surface of the Cu_{1.81}S composite. Herein, an N₂ molecule, i.e., the reactant of the NRR for the NH₃ synthesis, or NₓH_{y} molecules, i.e., intermediates produced by bonding one or more H⁺ ions to the N₂ molecule, may be adsorbed to at least one specific Cu atom of the three Cu atoms in a specific group within a specific 3-fold coordination site among the 3-fold coordination sites, and it will be described in detail below by referring to FIGS. 3A to 3C.

For reference, the structure of the Cu_{1.81}S molecule illustrated in (e) of FIG. 1 may correspond to the space group P43212 (No. 96), the structure of the CuS composite illustrated in (d) of FIG. 1 for comparison may correspond to the space group P63/mmc (No. 194), and the structure of the Cu₂S composite illustrated in (f) of FIG. 1 may correspond to the space group P21/c (No. 14).

Next, each of (d) to (f) of FIG. 1 shows the distance between Cu atoms, which is calculated from the information of the RDF (Radial Distribution Function) graph (i) of FIG. 1.

By referring to (g) of FIG. 1, the Cu—S distances in the CuS, Cu_{1.81}S, and Cu₂S composites are similar, with an average of about 2.3 Å, and referring to (h) of FIG. 1, the CuS composite has a narrower range of r than the others as it includes S—S covalent bonds, unlike the others. Also, referring to (i) of FIG. 1, the CuS composite has a Cu—Cu distance of 3.84 Å, which is much bigger than 2.95 Å of the Cu_{1.81}S composite and 2.65 Å of the Cu₂S composite. Accordingly, it can be seen that the density of Cu atoms per unit area is higher in the Cu_{1.81}S and Cu₂S composites than in the CuS composite, and thus, the activities of the NRRs performed at the 3-fold coordination sites are expected to be higher in the Cu_{1.81}S and Cu₂S composites than in the CuS composite.

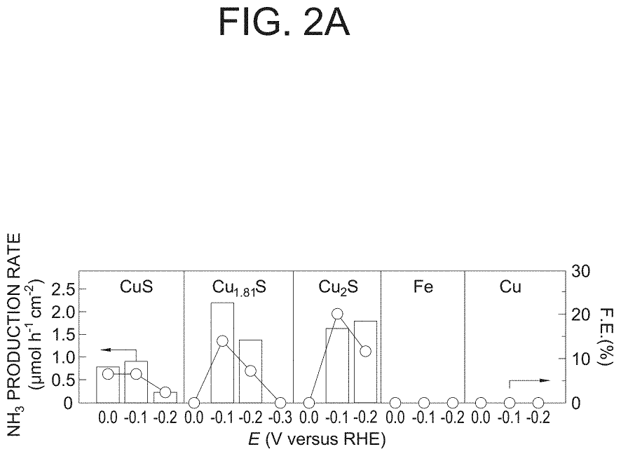

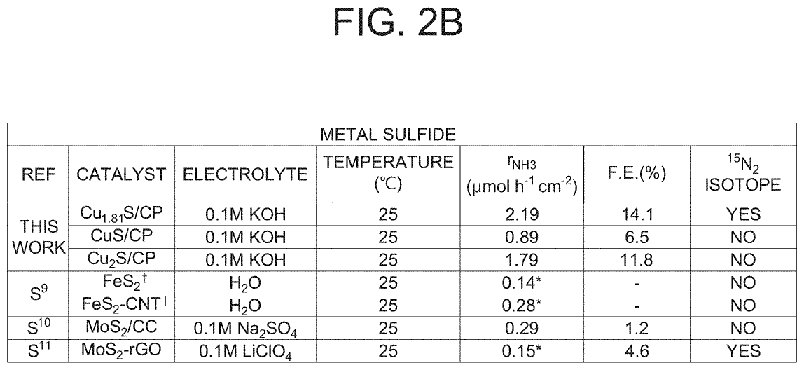

FIG. 2A is a drawing illustrating NH₃ production rates and Faradaic Efficiencies (F.E.) to potentials (V versus reversible hydrogen electrode) of the CuS, Cu_{1.81}S, and Cu₂S composites, and monometallic Fe and Cu, in accordance with one example embodiment of the present disclosure.

Referring to FIG. 2A, the NH₃ synthesis rate varies depending on the potential (V versus RHE) applied to the CuS, Cu_{1.81}S, and Cu₂S composites, and the Cu_{1.81}S composite shows its highest NH₃ production rate of 2.19 μmol h⁻¹ cm⁻² and its Faraday efficiency of 14.1% at−0.10 V (vs RHE).

This means that the Cu_{1.81}S composite has a higher performance as a catalyst for the NRR for the NH₃ synthesis in comparison to the CuS composite showing its highest NH₃ production rate of 0.89 μmol h⁻¹ cm⁻² and its Faraday efficiency of 6.5% at −0.10 V (vs RHE), and the Cu₂S composite showing its highest NH₃ production rate of 1.79 μmol h⁻¹ cm⁻² and its Faraday efficiency of 11.8% at −0.20 V (vs RHE).

In addition, it can be seen that NH₃ is not produced by using the monometallic Fe and Cu catalysts when potentials in the same range as above are applied, which means the NRR does not occur, and thus the monometallic Fe and Cu have lower performances as a catalyst for the NH₃ synthesis than the copper sulfide composites.

Further, as shown in FIG. 1, since the Cu—Cu distance is shorter in the Cu₂S composite than in the Cu_{1.81}S composite, the Cu_{1.81}S composite shows a higher peak in the NH₃ production rate at −0.1 V (vs RHE) even though the density of Cu atoms per unit area is higher in the Cu₂S composite, and this means that a large number of 3-fold coordination sites may be formed on the surface of the Cu_{1.81}S composite.

FIG. 2B is a drawing illustrating experimental data of highest activities of the copper sulfide catalysts CuS, Cu_{1.81}S, and Cu₂S and conventional bioinspired catalysts FeS₂ and MoS₂, in nitrogen reduction reactions(NRR) for the NH₃ synthesis, in accordance with one example embodiment of the present disclosure.

By referring to FIG. 2B, it can be seen the data of the experiments performed under conditions of room temperature and pressure to measure the maximum NH₃ production rate and Faraday efficiencies for the CuS, Cu_{1.81}S, and Cu=2S composites. Also, by comparing the experimental data of conventional FeS₂ and MoS₂ as catalysts, it can be seen that the maximum NH₃ production rates and Faraday efficiencies of the copper sulfide composites are higher than them.

FIG. 3A is a drawing schematically illustrating pathways of a nitrogen reduction reaction for the NH₃ synthesis which are initiated by adsorption of N₂ molecules on a surface of Cu_{1.81}S, in accordance with one example embodiment of the present disclosure.

For reference, in FIG. 3A, *(asterisk) denotes that an element or a molecule therewith is adsorbed or produced on the surface of the Cu_{1.81}S composite, and it is omitted in the detailed description and the claims of the present disclosure.

Referring to FIG. 3A, the NRR for synthesizing NH₃ molecules with an N₂ molecule adsorbed on the surface of the Cu_{1.81}S composite may be performed through a common reaction pathway and then two separated reaction pathways. Each reaction pathway will be described in detail as follows.

[1. Common pathway] In a common reaction pathway before separated into the two reaction pathways, a step of proceeding with a state I and a step of transition from the state I to a state II may be performed.

First, the state I may be proceeded when an N₂ molecule is adsorbed to at least one specific Cu atom of three Cu atoms in a specific group within a specific 3-fold coordination site among the 3-fold coordination sites formed on the surface of the Cu_{1.81}S composite. The adsorption of the N₂ molecule may indicate that the N₂ molecule, i.e., the reactant of the NRR, is bonded to the specific Cu atom, and one of two N atoms of the adsorbed N₂ molecule may be bonded to at least one specific Cu atom of the three Cu atoms in the specific group within the specific 3-fold coordination site. Herein, the “group” means a set of three Cu atoms included in a 3-fold coordination site. Further, the “specific group” means a set of three Cu atoms included in the specific 3-fold coordination site.

Next, at the step of transition from the state I to state II, one of two N atoms of the adsorbed N₂ molecule may be bonded to one of the three Cu atoms in the specific group within the specific 3-fold coordination site, and the other one of the two N atoms may be bonded to the other ones of the three Cu atoms in the specific group. Then, an H⁺ ion may be bonded to a first N atom of the two N atoms from the specific S atom as a proton donor, to thereby produce an N₂H molecule as a first intermediate. Herein, an electron(e−) may be transferred when the H⁺ ion is bonded to the first N atom not only at the above step of transition from the state I to the state II, but also at other steps where an H⁺ ion is bonded to an N atom during the entire NRR.

However, during the NRR using the Cu_{1.81}S composite as a catalyst, an additional state I′ may be included between the state I and the state II, and an additional step of transition from the state I to the state I′ and an additional step of transition from the state I′ to a state II may be proceeded. At the step of transition from the state I to the state I′, protonation may be performed in which the H⁺ ion is bonded to a specific S atom adjacent to the specific 3-fold coordination site. Then, at the step of transition from the state I′ to the state II, the specific S atom, as a proton donor may provide the H⁺ ion to the first N atom of the two N atoms, to thereby produce an N₂H molecule as a first intermediate and thus form a hydrogen bond between the specific S atom and the H⁺ ion provided to the first N atom. Herein, the formation of the hydrogen bond, which is represented as “ . . . ”, may stabilize N₂H_{y} (y is 1 to 4) molecules as intermediates, including the first intermediate (N₂H).

Referring to FIG. 3C, it is illustrated that the N₂H molecule is produced as the first intermediate at the specific 3-fold coordination site formed on the surface of the Cu_{1.81}S composite and a hydrogen bond is formed between the specific N atom and the H⁺ ion provided to the produced N₂H molecule.

Further, as mentioned above, since the additional state I′ is included in the case of using the Cu_{1.81}S composite as the catalyst, a limiting potential (UL) required for the NRR to occur may be reduced, and this will be described in detail with reference to FIG. 3B as follows.

FIG. 3B is a drawing illustrating free-energy diagrams of the NRRs on the Cu_{1.81}S composite, the monometallic Cu, and the monometallic Fe as catalysts for the NH₃ synthesis, in accordance with one example embodiment of the present disclosure.

In FIG. 3B, the diagrams show changes in free energy according to steps in which additional H⁺ ions and electrons (e−) are bonded to the N atoms on each of the Cu_{1.81}S composite, the monometallic Cu, and the monometallic Fe. Through the free energy diagrams, the potential-determining steps (PDS) for the NRRs may be specified, in which energy corresponding to the limiting potential (UL) required for the NRR is determined.

For reference, the free energy diagrams of (b), (c), and (d) in FIG. 3B are results of the Density Functional Theory (DFT) calculation under conditions of pH=13.3 and U=0 V (vs RHE).

Referring to the free energy diagram of (b) in FIG. 3B, it can be seen that 1.2 eV of energy is required for the transition from the state I to the state I′, and the corresponding step may be specified as a PDS. This means that the limiting potential required for the NRR may be significantly reduced due to the inclusion of the additional state I′ since 2.0 eV of energy (not illustrated) is required for the transition from the state I directly to the state II, without the state I′.

Referring to FIG. 3A again, at the state II where the N₂H molecule is produced as the first intermediate, the two reaction pathways for the NRR may proceed depending on which one among the two N atoms of the first intermediate(N₂H) a first additional H⁺ ion is bonded to.

[2. First reaction pathway: distal pathway] The first reaction pathway may be initiated by transition from the state II to a state III. That is, at a step of the transition from the state II to the state III, an N₂H₂ molecule may be produced as a (2_1)-st intermediate by bonding the first additional H⁺ ion to the first N atom among the two N atoms in the first intermediate (N₂H), wherein an H⁺ ion has been already bonded to the first N atom in the state II.

Next, at a step of transition from the state III to a state IV, a second additional H⁺ ion may be bonded to the first N atom included in the (2_1)-st intermediate (N₂H₂) so that the first N atom is separated from the (2_1)-st intermediate in a form of a (1_1)-st NH₃ and the second N atom remains as a third intermediate on the surface of the copper sulfide catalyst.

Then, at a step of transition from the state IV to a state V, an NH molecule as a fourth intermediate may be produced by bonding a third additional H⁺ ion to the second N atom as the third intermediate. At a step of transition from the state V to a state VI, an NH₂ molecule as a fifth intermediate may be produced by bonding a fourth additional H⁺ ion to the second N atom included in the fourth intermediate. Finally, at a step of transition from the state VI to a state VII, a (2_1)-st NH₃ molecule may be produced by bonding a fifth additional H⁺ ion to the second N atom included in the fifth intermediate.

[3. Second reaction pathway: mixed pathway] Differently from the first reaction pathway as described above, the second reaction pathway may be initiated by transition from the state II state to a state III′. That is, at a step of the transition from the state II to the state III′, the first additional H⁺ ion may be bonded to the second N atom to which the H⁺ ion is not bonded in the II state among the N atoms, and thus an N₂H₂ molecule having a condensed structural formula of NHNH may be produced as a (2_2)-nd intermediate, wherein no H⁺ ion has been bonded to the second N atom in the state II.

Next, at a step of transition from the state III′ to a state IV′, an N₂H3 molecule may be produced as a sixth intermediate by bonding a sixth additional H⁺ ion to one N atom among the first and the second N atoms included the (2_2)-nd intermediate.

At a step of transition from the state IV′ to a state V, bonding a seventh additional H⁺ ion to said one N atom, to which the first and the sixth additional ions have already been bonded, included in the sixth intermediate so that said one N atom is separated from the sixth intermediate in a form of a (1_2)-nd NH₃ molecule and an NH molecule remains as a seventh intermediate on the surface of the copper sulfide catalyst.

Then, after proceeding with steps of transition from the state V to a state VI, and transition from the state VI to a state VII, a (2_2)-nd NH₃ molecule is produced as a final NRR. Since a process of producing the (2_2)-nd NH₃ is similar to that of producing the (2_1)-st NH₃ in the first reaction path, its detailed description will be omitted.

Meanwhile, FIG. 3A additionally shows a pathway of transition from the state IV′ to the state VI via a state V′. This pathway, as an alternative pathway different from the mixed pathway (i.e., the second reaction pathway), includes a step of producing an N₂H4 molecule as a ninth intermediate by bonding the seventh additional H⁺ ion to the other N atom, to which only the sixth additional ions have already been bonded, among the first and the second N atoms included in the sixth intermediate(N₂H3), and then a step of bonding a tenth additional H⁺ ion to one N atom among the first and the second N atoms included in the ninth intermediate(N₂H4) so that a (1_3)-rd NH₃ molecule is produced from the eighth intermediate(N₂H4) and an NH₂ molecule remains as a tenth intermediate on the surface of the copper sulfide catalyst.

However, referring to (b) in FIG. 3B, large energy is required for the transition from the state IV′ to the state V′ in the alternative pathway. That is, it is expected that the state V rather than the state V′ is more likely to follow the state IV′, and thus it can be seen that the alternative pathway is more difficult to occur than the mixed pathway.

Further, referring to the free energy diagram (b) in FIG. 3B, there is no big difference in energy between the first reaction pathway of the transition from the state II to the state IV via the state III, and the second reaction pathway of the transition from the state II to the IV′ state via the state III′. And the actual difference in energy between the transition from the state III to the state IV and the transition from the state III′ to the state IV′ is only 0.1 eV. Since it is much smaller than 1.2 eV, which is the energy required for the transition from the state I to the state I′, determined as the PDS for the NRR on the Cu_{1.81} composite, both the first reaction pathway and the second reaction pathway may proceed in the NRR. That is, the NH₃ molecules may be synthesized at each 3-fold coordination site among the 3-fold coordination sites formed on the surface of the copper sulfide catalyst by the NRR through one of (i) the first reaction pathway which is initiated when the first additional H⁺ ion is bonded to the first N atom included in the first intermediate, and (ii) the second reaction pathway which is initiated when the first additional H⁺ ion is bonded to the second N atom of the two N atoms included in the first intermediate. Also, this means that the activity of the NRR on the surface of the Cu_{1.81}S composite as the catalyst may be higher than other catalysts which tend to take only one pathway.

[Comparison with monometallic Cu]

The free energy diagrams of the monometallic Cu catalyst and the monometallic Fe catalyst may be compared to the free energy diagram of the Cu_{1.81}S composite, as follows.

In FIG. 3B, (c) is a free energy diagram of the monometallic Cu catalyst. Herein, it can be seen that energy is required the most for transition from the state I, where an N₂ molecule is adsorbed to a Cu atom, to the state II, where an H⁺ ion is bonded to the adsorbed N₂ molecule, and thus the step corresponding thereto, as a PDS for the NRR on the monometallic Cu, requires an energy of 2.5 eV. This is higher than 2.0 eV, which is the energy required for the transition from the state I to the state II, without the state I′, on the Cu_{1.81}S composite. Therefore, the NRR may be more difficult to proceed on the monometallic Cu than on the Cu_{1.81}S composite.

[Comparison with the monometallic Fe]

In FIG. 3B, (d) is a free energy diagram of the monometallic Fe catalyst. Herein, a PDS for the NRR on the monometallic FE is the step of the transition from the state V to the state VI, and it requires an energy of 1.6 eV. This is higher than 1.2 eV which is the energy required for the transition from the state I to the state I′ and its corresponding step is the PDS for the NRR on the Cu_{1.81}S composite. This means that the NRR may be difficult to proceed on the monometallic Fe compared to the Cu_{1.81}S composite.

Further, referring to the free energy diagram of the monometallic Fe catalyst, the biggest energy difference between the distal pathway, which corresponds to the first reaction pathway including the step of the transition from the state III to the state IV, and the mixed pathway, which corresponds to the second reaction pathway including the step of the transition from the state III′ to the state IV′, is the energy difference between the step of the transition from the state III to the state IV, and the step of the transition from the state III′ to the state IV′. Said biggest energy difference is 3.2 eV, which is much bigger than 1.6 eV of energy required at a PDS for the NRR on the monometallic Fe catalyst. Therefore, during the NRR using the monometallic Fe catalyst, the distal pathway of the transition from the state III to the state IV is more likely to proceed while the mixing pathway of transition from the state III′ to the state IV′ is unlikely to proceed.

[Preparation of Cu_{1.81}S composite] Below, it will be explained a method for synthesizing the Cu_{1.81}S composites of the present disclosure from a Cu—S mixture by using a ball-milling process and a wet-milling process in accordance with one example embodiment of the present disclosure.

FIG. 4 is a drawing schematically illustrating methods of synthesizing the Cu_{1.81}S composite from a Cu—S mixture, in accordance with one example embodiment of the present disclosure.

Referring to FIG. 4, the method for synthesizing the Cu_{1.81}S composite according to the present disclosure is basically to perform at least part of the ball-milling process, an annealing process, and the wet-milling process.

Specifically, in accordance with one example embodiment of the present disclosure, the method for synthesizing the Cu_{1.81}S composite may start with a step of producing the Cu—S mixture as a first precursor for synthesizing the Cu_{1.81}S composite by mixing Cu powder and S powder in a certain molar ratio.

Next, the Cu—S mixture produced as the first precursor may undergo the wet-milling process. Herein, depending on the execution time of the ball-milling process, a Cu_{1.96}S composite or a Cu_{1.81}S composite may be produced as a second precursor for synthesizing the Cu_{1.81}S composite.

The ball-milling process may be a dry ball-milling where a solvent is not used, unlike the wet-milling process to be described later.

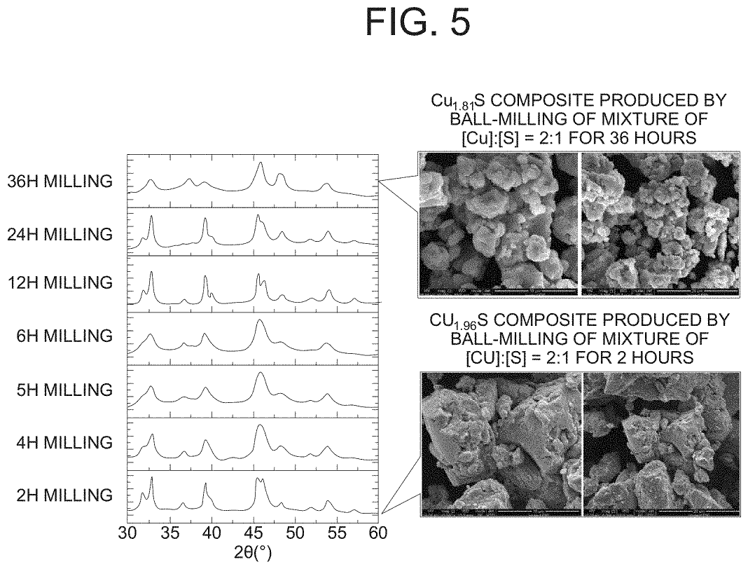

FIG. 5 shows data of an actual experimental example related to the execution time of the ball-milling process of the Cu—S mixture as the first precursor.

FIG. 5 is a drawing illustrating XRD graphs of results over time of a ball-milling process of the Cu—S mixture, and SEM images of the Cu_{1.96} composite and the Cu_{1.81}S composite, each of which is produced by the ball-milling process for each certain period of the execution time, in accordance with one example embodiment of the present disclosure.

By referring to FIG. 5, data of XRD (X-Ray Diffraction) analysis on resultants produced after specific execution times in the ball-milling process of the Cu—S mixture performed for up to 36 hours is shown in graphs. Based on each pattern of such XRD graphs, it can be seen that the Cu_{1.96}S composite is produced by performing the ball-milling process for 2 hours, whereas the Cu_{1.81}S composite is produced by performing the ball-milling process for 36 hours. Also, SEM images of the generated Cu_{1.96}S and Cu_{1.81}S composites at the same magnification (left: 10,000 times, right: 5,000 times) are shown in FIG. 5. By referring thereto, it can be seen that the Cu_{1.81}S composite which is produced by performing the ball-milling process for 36 hours has a smaller particle size than the Cu_{1.96}S composite which is produced by performing the ball-milling process for 2 hours.

Next, when the Cu_{1.96}S composite is produced as the second precursor by the aforementioned process, the Cu_{1.96}S composite as the second precursor or its processed product as a third precursor may undergo the wet-milling process, thereby generating the Cu_{1.81}S composite. Herein, the Cu_{1.81}S composite, i.e., the final product, may have a tetragonal structure, according to the detailed implementation conditions of the present disclosure.

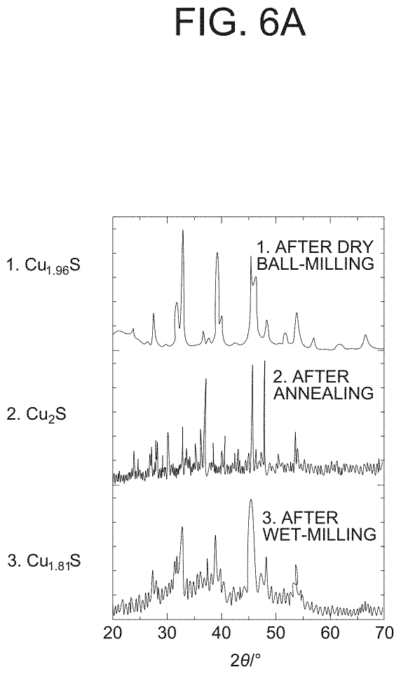

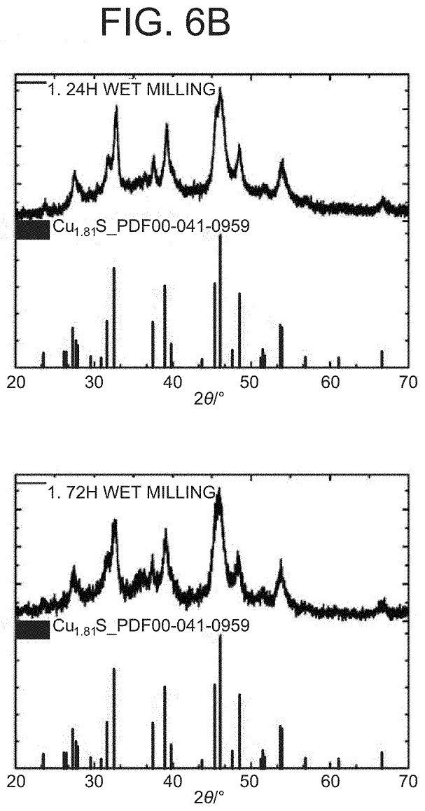

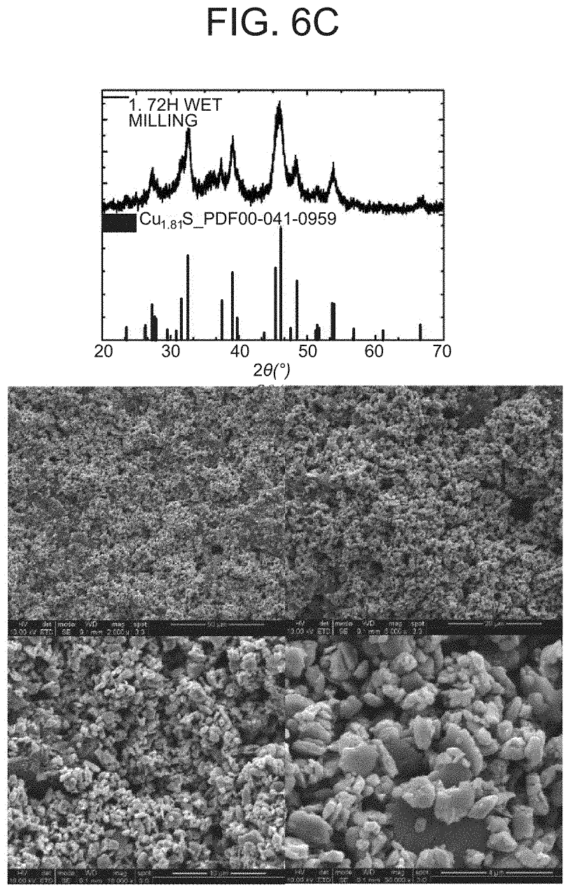

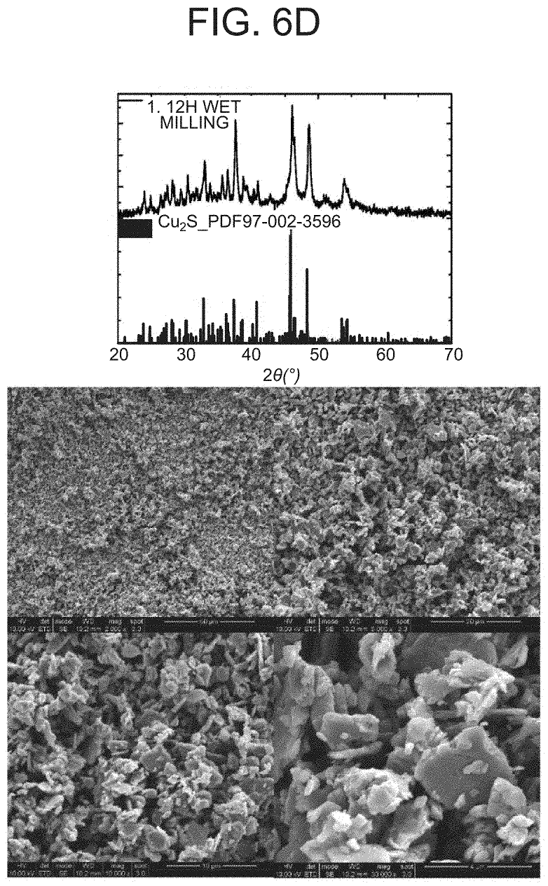

There are three methods for synthesizing the Cu_{1.81}S composite based on the aforementioned ball-milling process and wet-milling process, as shown in FIG. 4, and they will be described in detail below with reference to specific example embodiments and drawings.

[Method 1 for preparation of Cu_{1.81}S composite] One specific example embodiment of synthesizing the Cu_{1.81}S composite in the present disclosure will be described with reference to FIGS. 6A to 6D as follows.

FIG. 6A is a drawing illustrating XRD graphs of the Cu_{1.96}S composite, which is produced by the ball-milling process of the Cu—S mixture, the Cu₂S composite, which is produced by annealing the Cu_{1.96}S composite, and the Cu_{1.81}S composite, which is produced by a wet-milling process of the Cu₂S composite, in accordance with one example embodiment of the present disclosure.

First of all, the Cu—S mixture may be produced as the first precursor for synthesizing the Cu_{1.81}S composite by mixing the Cu powder and the S powder in a certain molar ratio. Herein, as one example of experiment conditions, the molar ratio of the Cu powder and the S powder may be set as [Cu]:[S]=2:1, and thus a mass ratio of the Cu powder and the S powder used to produce the first precursor may be 4:1, but is not limited thereto. Further, the molar ratio and the mass ratio may vary according to implementation conditions of the present disclosure.

In an actual experimental example for the present disclosure, 3.993 g of the Cu powder (Alfa Aesar, 99.9%) and 1.007 g of the S powder (Sigma-Aldrich, 99.98%) were used to produce 5 g of the Cu—S mixture as the first precursor without any additive or refinement.

Next, the ball-milling process may be performed by using the Cu—S mixture produced as the first precursor. Specifically, a first mass of the Cu—S mixture as the first precursor and a plurality of first grinding balls may be inputted to a vessel under an inert gas atmosphere, and undergoes the ball-milling process at a first rotation speed for a first ball-milling time. As one example of experiment conditions, the first mass of the Cu—S mixture as the first precursor may be 5 g, and the plurality of the first grinding balls may be made of a ceramic material such as zirconia (ZrO2). Also, different grinding balls may be mixed for use. In addition, in the present disclosure, argon (Ar) may be used for the inert gas atmosphere, and the vessel for the ball-milling process may be a stainless-steel vessel. Further, the first rotation speed may be 500 rpm, and the first ball-milling time may be 2 hours. However, the first mass of the first precursor, the number and material of the first grinding balls, the type of inert gas used for the inert gas atmosphere, the configuration of the vessel, the first rotation speed, etc. for the ball-milling process as above may be determined variously according to the implementation conditions of the present disclosure within a range in which the Cu_{1.81}S composite can be synthesized. And the first ball-milling time may be set variously within a range, in which the Cu_{1.96}S composite is produced as the second precursor by performing the ball-milling process for 2 hours. In addition, another speed unit may be used as a unit of the first rotation speed for the ball-milling process when the ball-milling process is performed in a manner other than rotation.

In one actual experimental example according to the present disclosure, 5 g of the Cu—S mixture as the first precursor and a total 50 g of two types of zirconia (ZrO2) balls (25 g of 5 mm diameter balls, and 25 g of 10 mm diameter balls) were inputted and sealed within the first vessel of 82 ml volume, made of stainless steel, in a glove box of the argon (Ar) atmosphere. Next, these were rotated at the first rotation speed of 550 rpm during the first ball-milling time of 2 hours in a planetary ball mill machine (Fritsch GmBH, Pulverisette 5 classic line). As a result, 5 g of the Cu_{1.96}S composite was produced as the second precursor. For reference, in the above experimental example, as pure Cu and S powder are used without an additive and the like, the Cu_{1.96}S composite also has a high purity and does not contain impurities.

FIG. 6A shows an XRD graph of the Cu_{1.96}S composite produced as the second precursor by performing the dry ball-milling process for 2 hours under the experimental conditions in the actual experimental example as above. (1. AFTER DRY BALL-MILLING) Then, the annealing process of the Cu_{1.96}S composite produced as the second precursor may be performed under predetermined annealing conditions. Specifically, the Cu_{1.96}S composite, i.e., the second precursor, may be annealed at 400° C. for 2 hours. The predetermined annealing conditions, such as temperature and time, may be determined variously within a range in which the Cu_{1.81}S composite can be synthesized according to the implementation conditions of the present invention.

As one actual experimental example for the present disclosure, 5 g of the Cu_{1.96}S composite produced by the dry ball-milling process as described above was inputted into a cylindrical furnace, and argon (Ar) gas was also inputted thereto at a flow rate of 200 sccm(standard cubic centimeter per minute). Then, in the argon (Ar) atmosphere, the annealing process was performed by heating the furnace at 400° C. for 2 hours with a heating rate of 5° C./min. As a result, 5 g powder of the Cu₂S composite (hereinafter, annealed Cu₂S composite) is produced as a third precursor.

FIG. 6A shows an XRD graph of the Cu₂S composite produce by performing the annealing process of the Cu_{1.96}S composite, i.e., the second precursor, for 2 hours under the experimental conditions of one actual experimental example as above. (2. AFTER ANNEALING)

Next, the annealed Cu₂S composite, which is produced as a third precursor, may undergo the wet-milling process.

Specifically, a second mass of the annealed Cu₂S composite as the third precursor, a plurality of second grinding balls, and a solvent may be inputted to a vessel for the wet-milling process, and the wet-milling process thereof may be performed at a second rotation speed for a first wet-milling time.

Herein, as one example of experiment conditions, the second mass of the inputted Cu₂S composite as the third precursor may be 2 g, and the plurality of the second grinding balls may be made of a ceramic material such as zirconia (ZrO2). Also, different grinding balls may be mixed for use. Further, the solvent used in the wet-milling process may include at least one of Isopropyl alcohol (IPA), Heptane, and Tetrahydrofuran (THF), and the vessel for the wet-milling process may be a Nalgene bottle. The bottle may be rotated at the second rotation speed of 200 rpm, and the first wet-milling time may be at least 24 hours. However, the second mass of the third precursor, the number and material of the second grinding balls, the material of the solvent, the configuration of the vessel, and the second rotation speed, and the first wet-milling time, etc. for the wet-milling process as above may be determined variously within a range in which the Cu_{1.81}S composite can be synthesized according to the implementation conditions of the present disclosure. Also, another speed unit may be used as a unit of the second rotation speed when the wet-milling process is performed in a manner other than rotation.

In the actual experimental example of the present disclosure, 2 g of the annealed Cu₂S composite as the third precursor, 8 ml of isopropyl alcohol (IPA, Daejung, 99.5%) as the solvent, and a total 45 g of two types of zirconia (ZrO2) balls (15 g of 5 mm diameter balls, and 30 g of lmm diameter balls) were input to a Nalgene (HDPE) bottle of 125 ml volume, and the wet-milling process thereof was performed at 200 rpm for 24 hours or 72 hours in a horizontal ball-milling equipment. As a result, the Cu_{1.81}S composite was produced in the form of colloids.

FIG. 6A shows an XRD graph of the Cu_{1.81}S composite produced by performing the wet-milling process of the annealed Cu₂S composite, as the third precursor, for a predetermined time under the experimental conditions in the actual experimental example as described above. (3. AFTER WET-MILLING) Herein, the wet-milling process in the actual experimental example was performed for 24 hours or 72 hours and is shown in more detail in FIG. 6B.

FIG. 6B is a drawing illustrating XRD graphs of the Cu_{1.81}S composites produced by the wet-milling process of the annealed Cu₂S composite for 24 hours and 72 hours respectively, in accordance with one example embodiment of the present disclosure.

By referring to FIG. 6B, the XRD graph indicates that the Cu_{1.81}S composite can be synthesized by performing the wet-milling process of the annealed Cu₂S composite for at least 24 hours. As more detailed experimental data, FIG. 6C shows an XRD graph and SEM images of the Cu_{1.81}S composite as a result of the wet-milling process of the annealed Cu₂S for 72 hours (clockwise from the top left, 2,000 times, 5,000 times, 30,000 times, and 10,000 times magnification).

Further, FIG. 6D shows an XRD graph and SEM images indicating that the result of performing the wet-milling process of the annealed Cu₂S composite for 12 hours is the Cu₂S composite (clockwise from the top left, 2,000 times, 5,000 times, 30,000 times, 10,000 times magnification), not the Cu_{1.81}S composite. Referring to FIG. 6D, it can be seen that the time for performing the wet-milling process is an important variable in order to synthesize the Cu_{1.81}S composite, which is the object to obtain in the present disclosure.

Also, additional examples of comparative experiments will be described below for comparison with the afore-described [Method 1 for preparation of the Cu_{1.81}S composite].

[Comparative experiments: change of solvent used in wet-milling process]

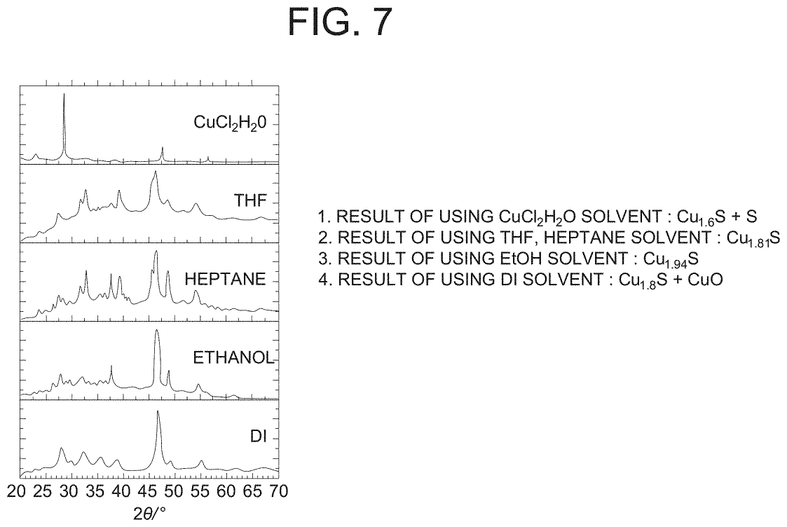

The comparative experiments for the afore-described [Method 1 for preparation of the Cu_{1.81}S composite] were performed by using different solvents in the wet-milling process, and this will be described with reference to FIG. 7. FIG. 7 is a drawing illustrating XRD graphs of products of the wet-milling process of the annealed Cu₂S composite using the different solvents, wherein the annealed Cu₂S composite is produced by annealing the Cu_{1.96}S composite produced by the ball-milling process of the Cu—S mixture, as examples for comparison with the present invention.

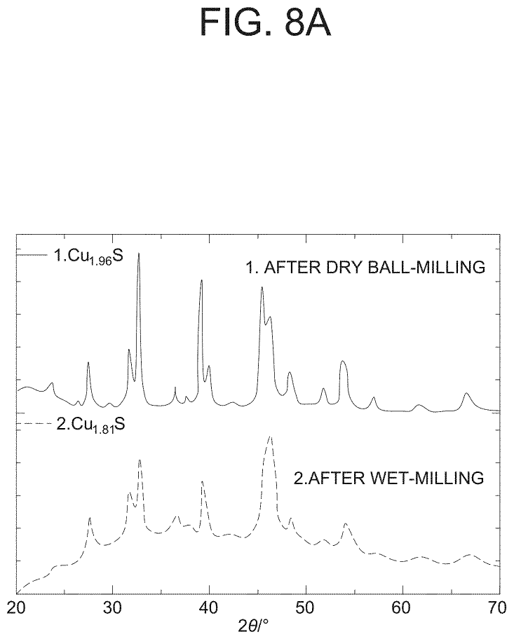

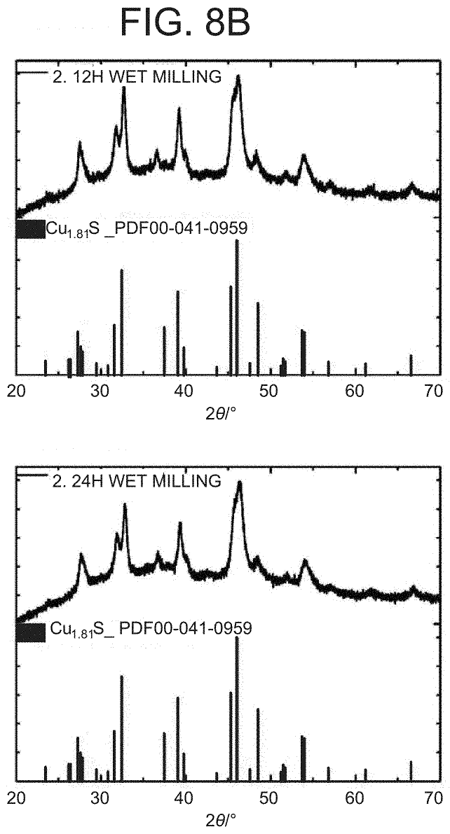

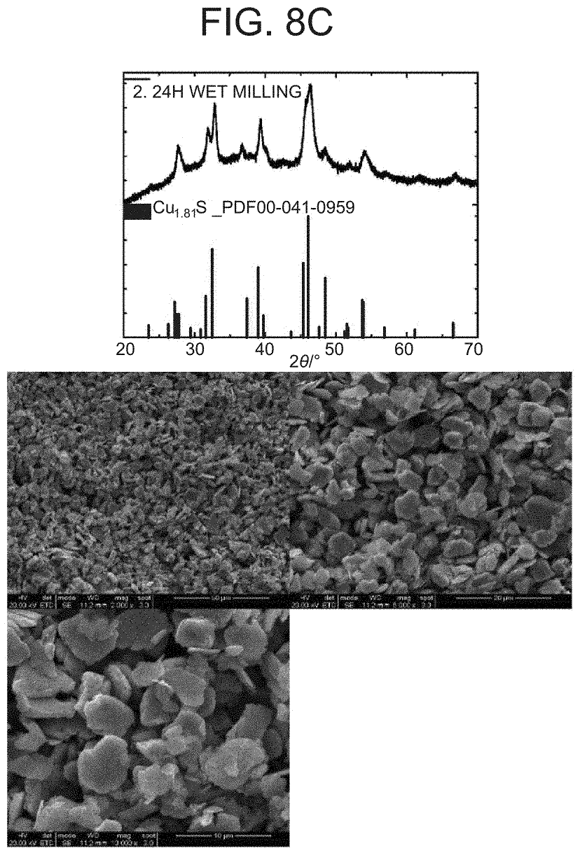

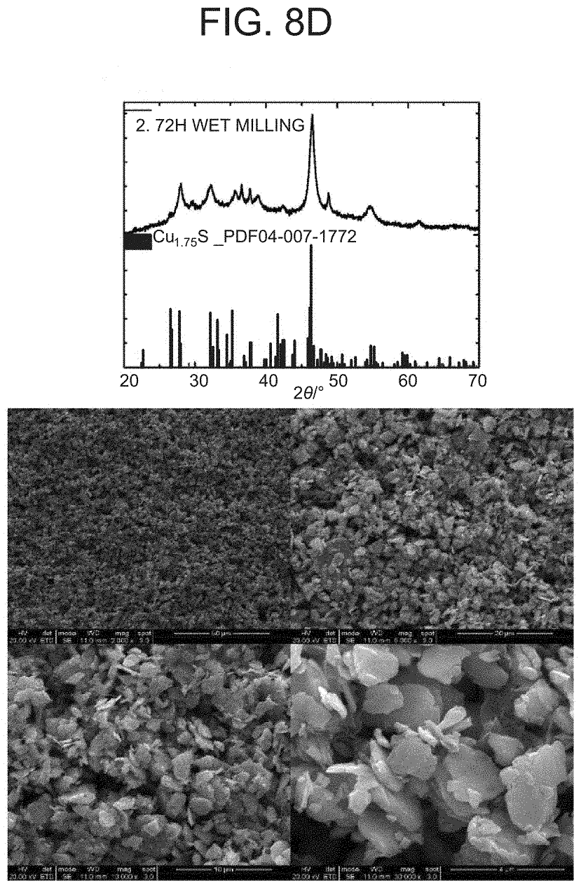

By referring to FIG. 7, the basic conditions and the processes of the [comparative experiments] are similar to those of the [Method 1 for preparation of the Cu_{1.81}S composite], but as the solvent for the wet-milling process, copper(II) chloride dehydrate (CuCl2H₂O), tetrahydrofuran (THF), heptane, ethanol, and Deionized water(DI), not IPA, were used. And the final products thereof are shown in XRD graphs in FIG. 7. As a result, it is found that the Cu_{1.81}S composite may be obtained as the final product in case of using Isopropyl alcohol (IPA), tetrahydrofuran (THF), or heptane as the solvent in the present disclosure. The Cu_{1.81}S composite produced herein has a tetragonal structure, and isopropyl alcohol (IPA) is used as the solvent in actual experiments for the present disclosure.

[Method 2 for preparation of Cu_{1.81}S composite] Another specific embodiment of the present disclosure for synthesizing a Cu_{1.81}S composite is a method of synthesizing the Cu_{1.81}S composite without performing the annealing process as in the above-described method 1 for preparation of the Cu_{1.81}S composite, and it will be described below with reference to FIGS. 8A to 8D.

FIG. 8A is a drawing illustrating XRD graphs of a Cu_{1.96}S composite produced by the ball-milling process of the Cu—S mixture, and a Cu_{1.81}S composite produced by the wet-milling process of the Cu_{1.96}S composite, in accordance with one example embodiment of the present disclosure.

First of all, the Cu—S mixture may be produced as a first precursor for synthesizing the Cu_{1.81}S composite by mixing the Cu powder and the S powder in a certain molar ratio, and the Cu_{1.96}S composite may be produced as a second precursor by the wet-milling process of the Cu—S mixture. The details of specific experimental conditions and actual experimental examples related to the Cu—S mixture and the Cu_{1.96}S composite as the second precursor herein are similar to those in the [Method 1 for preparation of Cu_{1.81}S composite], so a detailed description thereon is omitted.

FIG. 8A shows an XRD graph of the Cu_{1.96}S composite produced as the second precursor by performing the dry ball-milling process for 2 hours under the experimental conditions in the actual experimental example as above. (1. AFTER DRY BALL-MILLING)

Next, the Cu_{1.96}S composite, which is produced as the second precursor, may undergo the wet-milling process. Specifically, a third mass of the Cu_{1.96}S composite as the second precursor, a plurality of third grinding balls, and a solvent may be inputted to a vessel for the wet-milling process, and the wet-milling process thereof may be performed at a third rotation speed for a second wet-milling time. Herein, as one example of experiment conditions, the third mass of the Cu_{1.96}S composites as the second precursor may be 2 g, and the plurality of the third grinding balls may be made of a ceramic material such as zirconia (ZrO2). Also, different grinding balls may be mixed for use. Further, the solvent used in the wet-milling process may include at least one of Isopropyl alcohol (IPA), Heptane, and Tetrahydrofuran (THF), and the vessel for the wet-milling process may be a Nalgene bottle. The bottle may be rotated at the third rotation speed of 200 rpm, and the second wet-milling time may be 24 hours or more but less than 72 hours. However, the third mass of the second precursor, the number and material of the third grinding balls, the material of the solvent, the configuration of the vessel, and the third rotation speed, and the second wet-milling time, etc. for the wet-milling process as above may be determined variously within a range in which the Cu_{1.81}S composite can be synthesized according to the implementation conditions of the present disclosure. Also, another speed unit may be used as a unit of the third rotation speed when the wet-milling process is performed in a manner other than rotation.

In the actual experimental example of the present disclosure, 2 g of the Cu_{1.96}S composite as the second precursor, 8 ml of isopropyl alcohol (IPA, Daejung, 99.5%) as the solvent, and a total 45 g of two types of zirconia (ZrO2) balls (15 g of 5 mm diameter balls, and 30 g of lmm diameter balls) were input to a Nalgene (HDPE) bottle of 125 ml volume, and the wet-milling process thereof was performed at 200 rpm for 12 hours or 24 hours in a horizontal ball-milling equipment. As a result, the Cu_{1.81}S composite was produced in the form of colloids.

FIG. 8A shows an XRD graph of the Cu_{1.81}S composite produced by performing the wet-milling process of the Cu_{1.96}S composite, as the second precursor, for a predetermined time under the experimental conditions in the actual experimental example as described above. (2. AFTER WET-MILLING) Herein, the wet-milling process in the actual experimental example was performed for 12 hours or 23 hours and is shown in more detail in FIG. 8B.

FIG. 8B is a drawing illustrating XRD graphs of Cu_{1.81}S composites produced by the wet-milling process of a Cu_{1.96}S composite for 12 hours and 24 hours respectively, wherein the Cu_{1.96}S composite is produced by the ball-milling process of the Cu—S mixture, in accordance with one example embodiment of the present disclosure.

By referring to FIG. 8B, the XRD graph indicates that a Cu_{1.81}S composite can be synthesized by performing the wet-milling process of a Cu_{1.96}S composite for at least 24 hours. As more detailed experimental data, FIG. 8C shows an XRD graph and SEM images of the Cu_{1.81}S composite as a result of the wet-milling process of the Cu_{1.96}S composite for the 24 hours(clockwise from the top left, 2,000 times, 5,000 times, and 10,000 times magnification).

Further, FIG. 8D shows an XRD graph and SEM images indicating that the result of performing the wet-milling process of the Cu_{1.96}S composite as the second precursor for 72 hours is a Cu_{1.75}S composite (clockwise from the top left, 2,000 times, 5000 times, 30,000 times, 10,000 times magnification), not the Cu_{1.81}S composite. Referring to FIG. 8D, it can be seen that the time for performing the wet-milling process is an important variable in order to synthesize the Cu_{1.81}S composite, which is the object to obtain in the present disclosure.

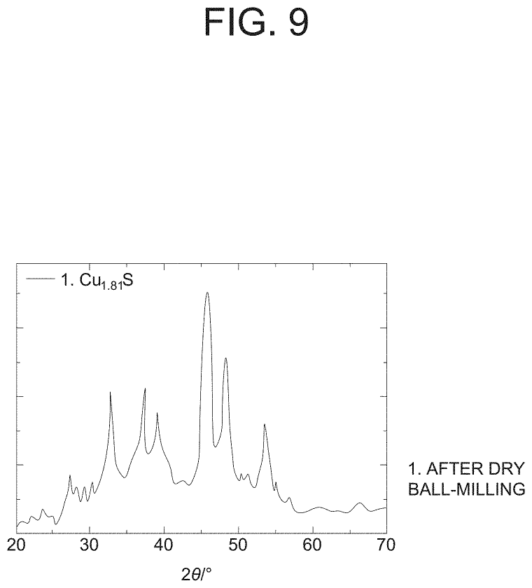

In addition, by comparing the [Method 1 for preparation of Cu_{1.81}S] and the [Method for preparation of Cu_{1.81}S composite], it is seen that the annealing process may increase a crystallinity of a resultant thereof, to thereby reduce a loss of Cu atoms during the wet-milling process.

[Method 3 for preparation of Cu_{1.81}S composite] Still another specific embodiment of the present disclosure for synthesizing a Cu_{1.81}S composite is a method of synthesizing the Cu_{1.81}S composite by controlling the time of the ball-milling process in the above-described method 2 for preparation of the Cu_{1.81}S composite, and it will be described below with reference to FIG. 9.

FIG. 9 is a drawing illustrating an XRD graph of a Cu_{1.81}S composite produced by the ball-milling process of the Cu—S mixture, in accordance with one example embodiment of the present disclosure.

First of all, the Cu—S mixture may be produced as a first precursor for synthesizing the Cu_{1.81}S composite by mixing the Cu powder and the S powder in a certain molar ratio. The details of specific experimental conditions and actual experimental examples related to the Cu—S mixture herein are similar to those in the [Method 1 for preparation of Cu_{1.81}S composite], so a detailed description thereon is omitted.

Next, the ball-milling process may be performed by using the Cu—S mixture produced as the first precursor. Specifically, a fourth mass of the Cu—S mixture as the first precursor and a plurality of fourth grinding balls may be inputted to a vessel in an inert gas atmosphere, and undergoes the dry ball-milling process at a fourth rotation speed for a second ball-milling time. As one example of experiment conditions, the fourth mass of the Cu—S mixture as the first precursor may be 5 g, and the plurality of the fourth grinding balls may be made of a ceramic material such as zirconia (ZrO2). Also, different grinding balls may be mixed for use. In addition, in the present disclosure, argon (Ar) may be used for the inert gas atmosphere, and the vessel for the ball-milling process may be a stainless-steel vessel. Further, the fourth rotation speed may be 500 rpm, and the second ball-milling time may be 36 hours. However, the fourth mass of the first precursor, the number and material of the fourth grinding balls, the type of inert gas used for the inert gas atmosphere, the configuration of the vessel, the fourth rotation speed, etc. for the ball-milling process as above may be determined variously according to the implementation conditions of the present disclosure within a range in which the Cu_{1.81}S composite can be synthesized. And the second ball-milling time may be set variously within a range, in which the Cu_{1.81}S composite is produced as a result of the ball-milling process for 36 hours. In addition, another speed unit may be used as a unit of the fourth rotation speed for the ball-milling process when the ball-milling process is performed in a manner other than rotation.

In one actual experimental example according to the present disclosure, 5 g of the Cu—S mixture as the first precursor and a total 50 g of two types of zirconia (ZrO2) balls (25 g of 5 mm diameter balls, and 25 g of 10 mm diameter balls) were inputted and sealed within the first vessel of 82 ml volume, made of stainless steel, in a glove box of the argon (Ar) atmosphere. Next, these were rotated at the first rotation speed of 550 rpm during the second ball-milling time of 36 hours in a planetary ball mill machine (Fritsch GmBH, Pulverisette 5 classic line). As a result, 5 g of the Cu_{1.81}S composite was produced. For reference, in the above experimental example, as pure Cu and S powder are used without an additive and the like, the Cu_{1.81}S composite also has a high purity and does not contain impurities.

FIG. 9 shows an XRD graph of the Cu_{1.81}S composite produced by performing the dry ball-milling process for 36 hours under the experimental conditions in the actual experimental example as above. (1 AFTER DRY BALL-MILLING)

The present disclosure has an effect of providing the copper sulfide catalyst to be used for increasing the efficiency of NH₃ synthesis.

The present disclosure has another effect of providing the copper sulfide catalyst that can be designed to have a ratio of the number of S atoms to that of Cu atoms as 1 or more.

The present disclosure has still another effect of providing the copper sulfide catalyst which can reduce limiting potential (UL) required for a nitrogen reduction reaction (NRR), and a method for synthesizing NH₃ using the copper sulfide catalyst.

The present disclosure has still yet another effect of providing the copper sulfide catalyst to proceed one of different two pathways of the NRR for the NH₃ synthesis, and the method for synthesizing NH₃ with high activity of the NRR by using the copper sulfide catalyst.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the spirit of the present disclosure must not be confined to the explained embodiments, and the following patent claims as well as everything including variations equal or equivalent to the patent claims pertain to the category of the spirit of the present disclosure.

1. A copper sulfide catalyst having a chemical formula of Cu_{1.81}S.

2. The copper sulfide catalyst of claim 1, wherein the copper sulfide catalyst is used for synthesizing NH₃ molecules via an electrochemical nitrogen reduction reaction (NRR).

3. The copper sulfide catalyst of claim 2, wherein a plurality of 3-fold coordination sites, each of which is comprised of each group of three Cu atoms, are formed on a surface of the copper sulfide catalyst.

4. The copper sulfide catalyst of claim 3, wherein a structure of the copper sulfide catalyst is tetragonal.

5. A method for synthesizing NH₃ by using the copper sulfide catalyst according to claim 1, comprising steps of:
(a) adsorbing an N₂ molecule to at least one specific Cu atom of the three Cu atoms in a specific group within a specific 3-fold coordination site among the 3-fold coordination sites formed on the surface of the copper sulfide catalyst;
(b) bonding an H⁺ ion to a specific S(sulfur) atom adjacent to the specific 3-fold coordination site; and
(c) (i) bonding one of two N atoms of the adsorbed N₂ molecule to one of the three Cu atoms in the specific group within the specific 3-fold coordination site, and the other one of the two N atoms to the other ones of the three Cu atoms in the specific group, and (ii) providing the H⁺ ion to a first N atom of the two N atoms from the specific S atom as a proton donor, to thereby produce an N₂H molecule as a first intermediate, and form a hydrogen bond between the specific S atom and the H⁺ ion provided to the first N atom.

6. The method of claim 5, wherein, after the step of (c), the NH₃ is synthesized by one of (i) a first reaction pathway which is initiated when a first additional H⁺ ion is bonded to the first N atom included in the first intermediate, and (ii) a second reaction pathway which is initiated when the first additional H⁺ ion is bonded to a second N atom of the two N atoms included in the first intermediate.

7. The method of claim 6, further comprising steps of:
(d1) producing an N₂H₂ molecule as a (2_1)-st intermediate by bonding the first additional H⁺ ion to the first N atom included in the first intermediate; and
(d2) bonding a second additional H⁺ ion to the first N atom included in the (2_1)-st intermediate so that the first N atom is separated from the (2_1)-st intermediate in a form of a (1_1)-st NH₃ and the second N atom remains as a third intermediate on the surface of the copper sulfide catalyst, wherein the steps of (d1) and (d2) are performed in the first reaction pathway.

8. The method of claim 7, further comprising steps of:
(e1) producing an NH molecule as a fourth intermediate by bonding a third additional H+ ion to the third intermediate;
(e2) producing an NH₂ molecule as a fifth intermediate by bonding a fourth additional H+ ion to the second N atom included in the fourth intermediate; and
(e3) producing a (2_1)-st NH₃ molecule by bonding a fifth additional H⁺ ion to the second N atom included in the fifth intermediate,
wherein the steps of (e1) to (e3) are performed in the first reaction pathway.

9. The method of claim 6, further comprising steps of:
(f1) producing an N₂H₂ molecule, which has a condensed structural formula of NHNH, as a (2_2)-nd intermediate by bonding the first additional H⁺ ion to the second N atom included in the first intermediate;
(f2) producing an N₂H3 molecule as a sixth intermediate by bonding a sixth additional H+ ion to one N atom among the first and the second N atoms included the (2_2)-nd intermediate; and
(f3) bonding a seventh additional H⁺ ion to said one N atom, to which the first and the sixth additional ions have already been bonded, included in the sixth intermediate so that said one N atom is separated from the sixth intermediate in a form of a (1_2)-nd NH₃ molecule and an NH molecule remains as a seventh intermediate on the surface of the copper sulfide catalyst,
wherein the steps of (f1) to (f3) are performed in the second reaction pathway.

10. The method of claim 9, further comprising steps of:
(g1) producing an NH₂ molecule as an eighth intermediate by bonding an eighth additional H⁺ ion to the other N atom among the first and the second N atoms which is included in the seventh intermediate; and
(g2) producing a (2_2)-nd NH₃ molecule by bonding a ninth additional H⁺ ion to said other N atom included in the eighth intermediate,
wherein the steps of (g1) and (g2) are performed in the second reaction pathway.

11. The method of claim 6, wherein the nitrogen reduction reaction(NRR) is performed under conditions of a 0.1M KOH electrolyte solution, and room temperature and pressure.
